(19) United States
(12) Patent Application Publication
(10) Pub. No.: US 2004/0177377 A1
(43) Pub. Date: Sep. 9, 2004

(54) One to many transmission method and system to transmit real-time video and audio data on wireless local area network

(75) Inventors: Yeong-shuenn Lin, Hsinchu (TW); Wei-jen Huang, Hsinchu (TW); Tse-hung Chu, Hsinchu (TW); Tung-sheng Li, Hsinchu (TW); Hsin-chi Chen, Hsinchu (TW)

Correspondence Address: BACON & THOMAS, PLLC, 625 SLATERS LANE, FOURTH FLOOR, ALEXANDRIA, VA, 22314

(73) Assignee: NewSoft Technology Corporation, Taipei (TW)

(21) Appl. No.: 10/436,089

(22) Filed: May 13, 2003

(30) Foreign Application Priority Data
Mar. 5, 2003 (TW) 92104756

(51) Int. Cl. H04N 7/173; H04N 7/18

(52) U.S. Cl. 725/81; 725/88; 725/102; 725/95

(57) ABSTRACT

A one-to-many transmission method and system to transmit real-time video and audio data on wireless local area network, which includes a first station, a second station, and at least one third station. The first station provides at least one video and audio program and a set-packet, and periodically transmits them to the second station. The second station transmits a command-packet to the first station to determine the content of video and audio program transmitted by the first station, and receives the set-packet to confirm whether the set-packet is correct or not. The third station intercepts and receives the set-packet, and according to the configuration of the set-packet changes its network configuration to receive the video and audio program transmitted by the first station, and selectively play the content.

### BACKGROUND OF THE INVENTION

1. Field of the Invention

The present invention relates to a transmission method and system to transmit real-time video and audio data on wireless local area network and, more particularly, to a one-to-many transmission method and system to transmit real-time video and audio data on wireless local area network.

2. Description of the Related Art

In a typical wireless local area network (WLAN) environment, a communication device such as a computer needs only to be equipped with an antenna or a wireless network card in order to be connected to the Internet through a wireless access point (AP). Because a wireless local area network (WLAN) has high scalability and is easy to administrate, it will not take an excessive amount of money to implement or expand cables to add the number of APs to the wireless communication network easily. Therefore, it lowers the operating cost for WLAN substantially, especially in system installation and maintenance. Besides, a WLAN has more advantages over a wired network in both the convenience of network installation and the mobility of its use. Therefore, the WLAN technology is most suitable for places where it is hard-to-wire and requires no physical infrastructure of LAN. For instance, a temporary network installation for an exhibition ground, a historical building worth preserving, or for offices or houses trying to avoid damaging its upholstery, etc.

Under the current WLAN technology standard, such as IEEE802.11 (Institute of Electrical & Electronics Engineers), two types of transmission mode are specified: the ad-hoc mode shown in FIG. 1a and the infrastructure mode as shown in FIG. 1b. Under the ad-hoc mode, each of stations (STAs) 101, 102, 103 can communicate with other STAs using wireless network card to form a network. Under the infrastructure mode, each of stations 101, 102, 103 can communicate with other STAs through an access point (AP) 104 to form a network. It can also be connected to a wired network 106 such as an Ethernet, and through the gateway 105 of the wired network 106 to the Internet 107.

However, under the infrastructure mode, communication among the STAs 101, 102, 103 must be transmitted via the access point (AP) 104. This drops the transmission efficiency. In the mean time, in order to transmit data, a station must wait for polling from the AP to coordinate the transmission order of the STAs, or it has to rival for transmission priority among the STAs. As a result, the STAs are in waiting status most of the time. In this situation, it disadvantages certain applications for the network services such as transmission of real-time videos and audios. To ensure an effective transmission of a real-time video and audio data, the best way is to transmit data in ad-hoc mode.

However, even if a real-time video and audio data is transmitted in ad-hoc mode, there still exist various problems to overcome. According to IEEE 802.11 standard, the method to broadcast video stream relies on the broadcast packets of the medium access control layer (MAC layer). Yet, according to the experiments, the chance of missing packet is very high. The amount of data transmitted may be reduced by almost 20%. Thus, it is hard to achieve the object of one-to-many transmission using the method of broadcasting.

In comparison with the wired network, it is easier to get external interference when data is transmitted in WLAN. Therefore, it is designed at the bottom layer of a network for hardware to test and verify the validity of a packet based on the Cyclic Redundancy Check Code (CRC). If it is a valid packet, the receiver then sends an acknowledgement (ACK) to notify the transmitter that data has been transmitted completely. If, after a predetermined period, the transmitter did not receive an ACK from the receiver, it then activates the resent process and retransmits the packet without an ACK. However, when transmitting broadcasting packets, the receiver does not send ACK, and the transmission is considered as successful by the transmitter after it broadcasts the packet. Thus, the transmitter does not know the actual transmitting status. This is one of the major causes of missing broadcasting packets.

Even the receiver sends an ACK after receiving the data to ensure the data integrity of the real-time video and audio data, this is only for one-to-one transmission. It still cannot achieve the object of one-to-many transmission. If a variety of real-time video and audio data is provided for one-to-one transmission, the mutual interference, for example, the overlapping of audio signals for different video and audio data will occur when the receiver plays back the real-time video and audio data. Therefore, even though the transmitter can transmit multiple real-time video and audio data, the receiver can only choose to play one single video and audio data. Thus, to provide multiple real-time video and audio data from the transmitter to a single receiver is impracticable from the economic aspect.

To sum up, the major challenge faced today for urgent improvement is to provide multiple real-time video and audio data from a single transmitter, using WLAN transmission, to a plurality of receivers, allowing selective playback of video and audio data, and to ensure the transmission quality of real-time video and audio data at the same time.

### SUMMARY OF THE INVENTION

In view of the above-mentioned problems, an object of the invention is to provide a one-to-many transmission method and system to transmit real-time video and audio data on wireless local area network from one single transmitter through WLAN to a plurality of receivers for selective playback of different video and audio data at anytime.

Another object of the invention is to provide a one-to-many transmission method and system to transmit real-time video and audio data on wireless local area network to ensure the transmission quality of the video and audio data.

In order to achieve the above-mentioned objects, a one-to-many transmission method to transmit real-time video and audio data on wireless local area network (WLAN) of the present invention includes a first station, a second station, and at least one third station. Data transmission among the first station, the second station, and the third station is in compliance with WLAN transmission standard, and it forms an ad-hoc mode WLAN among themselves. In which, the first station provides various video and audio programs of different contents to the WLAN.

First, according to the bandwidth available for the WLAN, the first station calculates the number of video and audio program it can hold. After that, the second station transmits a command-packet to the first station requesting for transmission of the video and audio program required. The first station acts in accordance with the command of the command-packet to complete the preparation of the corresponding command action. After the first station completes the corresponding preparation, it can then transmit a set-packet to the second station, in which, the related information about setting comprises a service set identifier (SSID) under ad-hoc mode, and a channel number, that is, the frequency been used. Any receiver can then based on the SSID and the channel number to modify its own network configuration, in order to receive the following network packet transmitted. Besides, the set-packet further comprises a list of video and audio programs to be transmitted, and the data-packet number and data byte number for each video and audio program. After the second station received the set-packet, it checks whether the set-packet is correct or not. If there are any errors occurred in the set-packet, resent the command-packet.

Once the set-packet transmitted by the first station is checked by the second station and is confirmed with no errors, transmission of data-packet is then started, which comprises the video and audio program designated by the second station. If the second station wishes to modify the content of the video and audio program, it then retransmits a command-packet to notify the first station. Even if there is no modifications for the video and audio programs, the second station still transmits the same command-packet periodically at a time interval, and the first station also transmits the set-packet periodically at a time interval followed with the retransmission of data-packets until the second station requests a termination of transmission for video and audio programs. The third station scans through all usable transmission channels for WLAN to intercept the set-packet. According to the corresponding configuration of the set-packet, the third station changes its network configuration in order to receive the data-packet transmitted by the first station and to play the selected video and audio program.

Furthermore, according to one aspect of the present invention, a one-to-many transmission system to transmit real-time video and audio data on WLAN comprises a first station, a second station, and at least one third station. The first station provides at least one video and audio program and a set-packet, which are transmitted periodically on a WLAN. The second station transmits a command-packet to the first station to determine the content of video and audio program which the first station transmit, and receives the set-packet transmitted by the first station, in order to confirm whether the set-packet is correct or not. The third station can intercept the set-packet and, according to the configuration of the set-packet, changes its network configuration to receive the video and audio program which the first station transmitted, and selectively play the content.

According to a one-to-many transmission method and system to transmit real-time video and audio data on wireless local area network of the invention, because the first station provides more than one video and audio programs simultaneously and the set-packet is transmitted periodically, the third station can receive and selectively play different video and audio program at any time. Besides, the set-packet is verified by the second station, which can prevent the third station from receiving incorrect set-packet and not able to receive the data-packet nor to play video and audio program correctly. Meanwhile, the transmission method between the first station and the second station is a one to one transmission, according to the network packet transmitted by the first station, the second station checks its CRC and returns an ACK. When an error occurred, the first station retransmits the error network packet, which includes data-packets that comprising video and audio program, in order to ensure the quality of the video and audio program the third station plays.

### BRIEF DESCRIPTION OF THE DRAWINGS

The above-mentioned and other objects, features, and advantages of the present invention will become apparent with reference to the following descriptions and accompanying drawings, wherein:

FIG. 1a is a schematic diagram showing architecture of a conventional wireless local area network (WLAN) in ad-hoc mode;

FIG. 1b is a schematic diagram showing architecture of a conventional WLAN in infrastructure mode;

FIG. 2 is a schematic diagram showing a one-to-many transmission method and system to transmit real-time video and audio data on WLAN according to one embodiment of the present invention;

FIG. 3 is a schematic diagram showing a first station of a one-to-many transmission method and system to transmit real-time video and audio data on WLAN according to one embodiment of the present invention;

FIG. 4 is a schematic diagram showing a second station of a one-to-many transmission method and system to transmit real-time video and audio data on WLAN according to one embodiment of the present invention; and

FIG. 5 is a schematic diagram showing a third station of a one-to-many transmission method and system to transmit real-time video and audio data on WLAN according to one embodiment of the present invention.

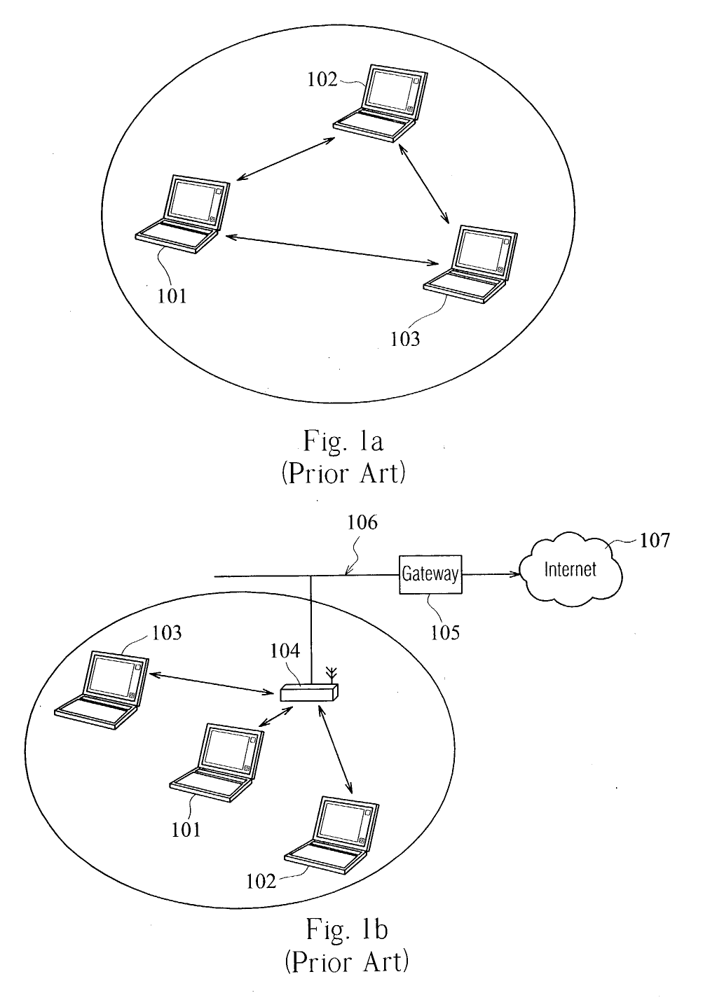

### DETAILED DESCRIPTION OF THE PREFERRED EMBODIMENTS

The preferred embodiments, according to the present invention, for a one-to-many transmission method and system to transmit real-time video and audio data on WLAN will be described in detail, with reference to the drawings in which like reference characters refer to the similar elements.

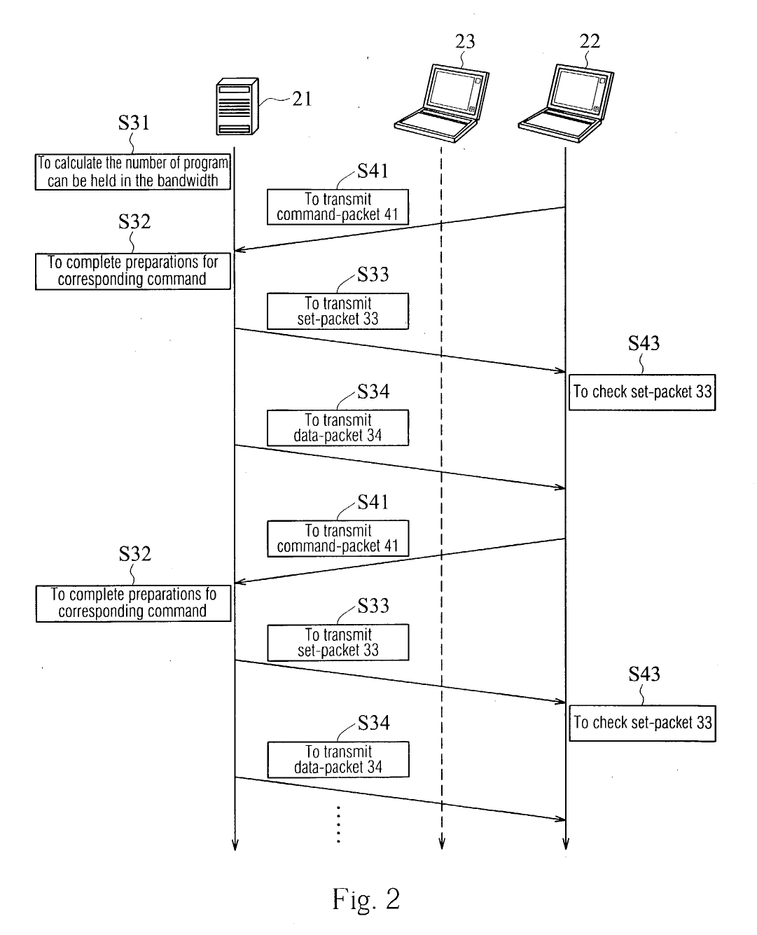

Referring to FIG. 2, a WLAN comprises a first station 21, a second station 22, and at least one third station 23. Data are transmitted between the first station 21, the second station 22, and the third station 23 with a WLAN transmission standard. These stations form a WLAN in ad-hoc mode with each other. The first station 21 provides various video and audio program with different contents to the WLAN. For instance, the first station 21 can be installed with an image capturing device to capture video and audio program played on the television or from a video tape, or through a CD-ROM device to read video and audio program from a video compact disc (VCD) or a digital versatile disc (DVD), and play.

In the following section, the implementation steps of the preferred embodiment for a one-to-many transmission method to transmit real-time video and audio data on WLAN will be described in detail. First, the first station 21, according to the bandwidth available for the WLAN, calculates the number of video and audio program it can accommodate (S31). Taking the WLAN with 802.11b standard from the IEEE as an example, the actual effective data transmission rate is approximately 4 to 5 Mbps. For video and audio programs in MPEG 1 (Motion Picture Experts Group) format, the bandwidth required is 1.5 Mbps, so 2 to 3 video and audio programs can be transmitted. For WLAN protocol with 802.11a standard from the IEEE, the actual effective data transmission rate is about 20 to 30 Mbps. According to data compression rate, 2 to 12 video and audio programs can be transmitted in MPEG 2 format.

Secondly, the second station 22 transmits a command-packet 41 (S41) to the first station 21, requesting for transmission of the required program. The first station 21 then acts in accordance with the command-packet 41 (detailed command actions will be described later) to complete the preparation tasks for the corresponding command actions (S32). For instance, the second station 22 requests for transmission of the television program and to play 2 video and audio programs from the VCD. The first station 21 captures the signals of the television program, drives the CD-ROM device to read the video and audio program from the VCD, and carry out buffering, such as storing data into a hard disk or memory.

After the first station 21 completes the related preparation tasks, a set-packet 33 including a service set identifier (SSID) under ad-hoc mode and a channel number indicating a frequency used can be then transmitted to the second station 22 (S33). Any receivers can then change its own network configuration based on the SSID and the channel number, in order to receive the following transmissions of network packet. Besides, the set-packet 33 further includes a list of video and audio programs to be transmitted, and the data-packet number and data byte number for each video and audio program. Using the above example, the list of video and audio programs records the name of television programs transmitted and the VCD programs played. The data-packet number and the data byte number of the program are recorded according to the result of the actual buffering. After receiving the set-packet 33, the second station 22 checks whether the set-packet 33 is correct or not (S43). If the set-packet 33 contains error, the second station 22 transmits the command-packet 41 to the first station 21 one more time.

After the set-packet 33 transmitted by the first station 21 is confirmed to be correct by the second station 22, the first station starts to transmit a data-packet 34 (S34) to the second station 22. The method for transmitting the data-packet 34 can be sequentially transmitted, or by integrating a plurality number of video and audio programs using a multiplexer before the transmission, and the receivers use a demultiplexer to capture the video and audio program and play it. Continued with the above-mentioned example, a single data-packet 34 containing only a television program can be transmitted at first. The next data-packet 34 transmitted contains only a first VCD program. The data-packet 34 transmitted after that contains only a second VCD program, and the data-packet 34 transmitted further after that contains only a television program. The data-packets 34 are transmitted in this manner repeatedly. After the television program and two VCD programs have been captured in succession, they can also be integrated by a multiplexer into a single data-packet 34 and then are transmitted out. In this case, the receiver uses a demultiplexer to select the required video and audio program from the single data-packet 34 for playing.

If the second station 22 expects to make a change on the video and audio program transmitted by the first station 21, it can transmit a command-packet 41 again to notify the first station 21. After completing the preparation tasks for the corresponding command actions, the first station 21 sends the modified set-packet 33. After the second station 22 has verified the modified set-packet 33, the first station 21 starts to transmit the data-packet 34. If the content of the video and audio program has not been changed, the second station 22 keeps transmitting the same command-packet 41 periodically with a predetermined time interval, and the first station 21 also transmits a set-packet 33 periodically with a predetermined time interval and then transmits a data-packet 34, until the second station 22 requests a termination of the transmission of the video and audio program.

Although the above-mentioned transmission process is for data transmission between the first station 21 and the second station 22, due to the transmission characteristics of WLAN, the third station 23 can scan for all of available WLAN transmission channels in order to intercept the set-packet 33. Provided that the third station 23 changes its network configuration according to the related configuration information of the set-packet 33, it can receive the following transmission of data-packet 34 transmitted by the first station 21 to select a video and audio program for playing. Besides, because the first station 21 transmits the set-packet 33 periodically, the third station 23 can, at any time, obtain the video and audio program from the set-packet 33 which is currently been transmitting on the WLAN.

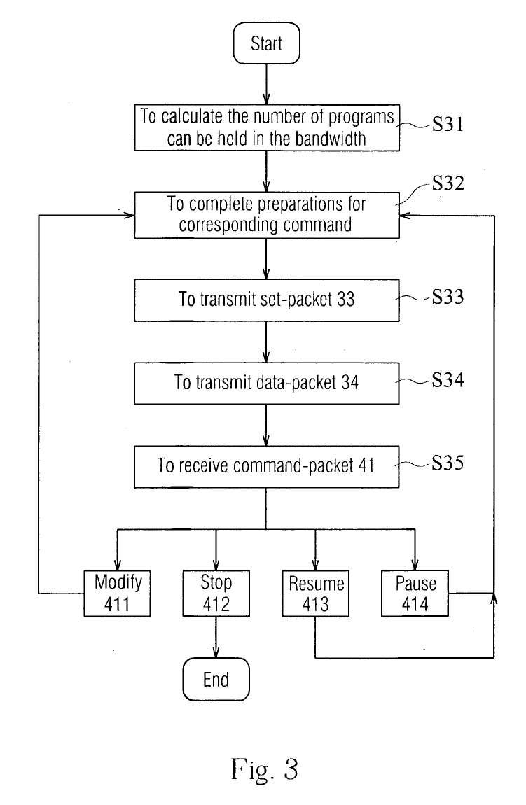

The preferred embodiment of the invention will be described below for a one-to-many transmission system for transmitting real-time video and audio data on WLAN, which comprises a first station 21, a second station 22, and a third station 23. As shown in FIGS. 3 to 5, the operation processes of the first station 21, the second station 22, and the third station 23 are illustrated.

As shown in FIG. 3, according to the bandwidth available for the WLAN, the first station 21 calculates for the number of video and audio programs it can accommodate (S31). After receiving the command-packet 41 transmitted by the second station 22, the first station 21 completes the corresponding preparations (S32) in accordance with the command-packet 41, such as complete buffering the requested transmission of at least one video and audio program by the second station 22. Next, proceed to step S33 to transmit a set-packet 33 to the second station 22. The set-packet 33 includes a service set identifier (SSID) in ad-hoc mode and a channel number indicating a frequency used. Any receivers can then modify its own network configuration based on the SSID and the channel number, in order to receive the following network packet transmitted. Besides, for each video and audio program, the set-packet 33 further includes a list of video and audio programs to be transmitted, and the data-packet number and the data byte number. After the set-packet 33 is checked and confirmed by the second station 22 to be correct, the transmission of the data-packet 34 is started (S34). That is, to start the transmission of at least one video and audio program requested by the second station 22. The method for transmitting the video and audio data are as those described earlier and therefore will not be described here again.

When the first station 21 receives a command-packet 41 again (S35), it follows the command of the command-packet 41 to complete the preparations (S32), repeats step S33 to transmit set-packet 33, and step S34 to transmit data-packet 34. In the command-packet 41, the major actions are modify 411, stop 412, resume 413, and pause 414.

When the first station 21 receives a modify command 411, it carries out the requested preparations for the contents of at least one video and audio program. Using the above-mentioned example, if the modify command 411 is to request for a change in the content of the VCD program to be played, the first station 21 carries out the buffering of related video and audio program. Or if the original transmission of television program is to be changed to transmitting real-time images taken by a video camera, the first station 21 must drive the related devices. When the first station 21 receives a pause command 414, it sets the requested program in the video and audio programs transmission to null. It also saves the video and audio data not transmitted to a storage device, such as a hard disk or memory. When the first station 21 receives a resume command 413, it checks if the requested program has been paused, and whether the storage device contains any video and audio data has not been transmitted. If so, it resumes the transmission of those video and audio data has not been transmitted. When the first station 21 receives a stop command 412, it stops the transmission of video and audio program and halts the system.

It should be noted that a timer can be set by the first station 21. If the first station 21 did not receive any command-packet 41 transmitted from the second station 22, the first station 21 then transmits directly the content of video and audio program been set previously. If the first station 21 did not receive any command-packet 41 in several successive transmissions, it can halt the system directly.

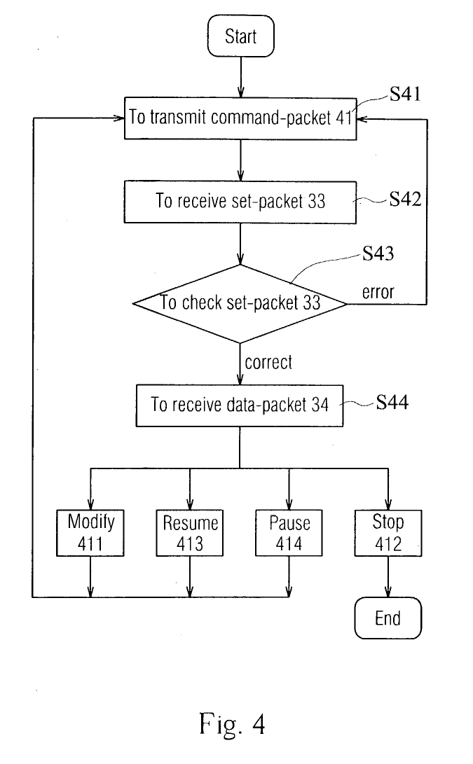

As shown in FIG. 4 is the operating process of the second station 22. When a system is activated, the second station 22 transmits command-packets 41 (S41), in order to modify the selected contents of at least one video and audio program transmitted by the first station 21, to pause or resume a video and audio program, and to stop the system. After transmitting a command-packet 41, it waits for receiving set-packets 33 transmitted by the first station 21 (S42), and checks whether the set-packet 33 is correct or not (S43). If the packet is incorrect, transmit the command-packet 41 again, asking the first station 21 to transmit the set-packet 33 again. It the packet is correct, it starts to receive data-packet 34 transmitted by the first station 21 (S44), which includes the video and audio program selected by the second station 22.

The second station 22 periodically repeats the step S41, S42, S43 and S44 to check whether the set-packet 33 transmitted by the first station 21 periodically is correct or not. If the second station 22 needs to modify the contents of a video and audio program, to pause or resume certain video and audio program, it can retransmit a command-packet 41 to the first station 21. If it is a stop command 412, quit the system, otherwise keeps checking the correctness of the set-packet 33.

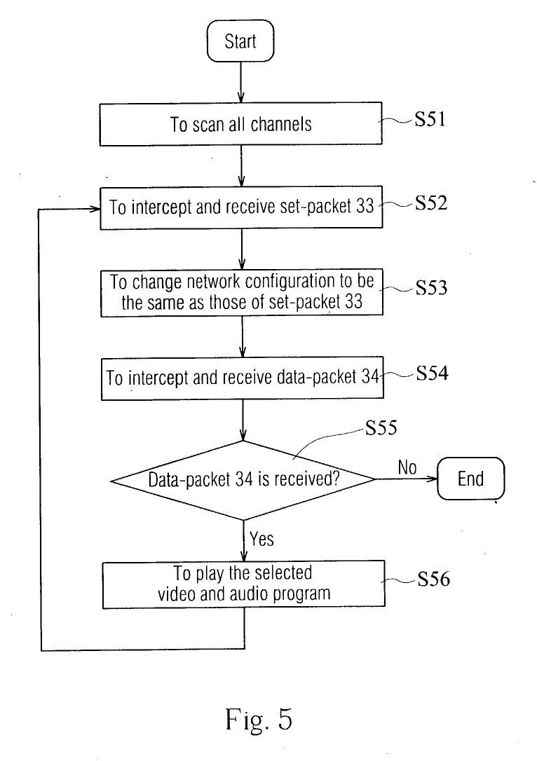

As shown in FIG. 5 is the operating process of the third station 23. If the third station 23 expects to receive and play a plurality number of video and audio programs transmitted by the first station 21, it first scans for all channels currently available for the WLAN (S51) and intercepts the set-packet 33 (S52). For instance, the IEEE 802.11b specifies at least three bands. For North American region standard, the mean frequencies of the three bands are 2412 MHz, 2437 MHz, and 2462 MHz, respectively. The third station 23 scans through these three bands to intercept the set-packet 33. The third station 23 changes its network configuration according to the SSID and channel number of the set-packet 33, to have the setting as those in the set-packet 33 (S53). The third station 23 then can receive the following data-packet 34 transmitted by the first station 21 (S54). If the third station 23 keeps receiving the data-packet 34 (S55), it proceeds to step S56 to play the video and audio program selected by the user. Otherwise, it terminates to intercept the data-packet 34. The user of the third station 23 can select a program to be played from the list of video and audio programs in the set-packet 33. The third station 23 then plays the selected program in accordance with the data-packet number and the data byte number of the video and audio program of the set-packet 33.

According to one embodiment of the present invention for a one-to-many transmission method and system to transmit real-time video and audio data on WLAN, the first station 21 can provide a plurality number of video and audio programs to a plurality number of third stations 23 to selectively play different video and audio programs. For example, if a third station 23 chooses to play a television program, it then picks out and plays the television program, according to relative information in the set-packet 33. In the meantime, if another third station 23 expects to play a VCD program, according to relative information in the set-packet 33, it can also pick out and play the VCD program. Similarly, other third station 23 can play another VCD program.

In addition, because set-packet 33 and data-packet 34 are transmitted periodically, any third stations 23 can change its network configuration at anytime, in accordance with the configuration of the set-packet 33, to receive data-packet 34 and play the video and audio program transmitted by the first station 21. Moreover, the set-packet 33 is checked by the second station 22 to ensure the correctness of the set-packet 33, in order to prevent the problem of unable to receive data-packet 34 and play the video and audio program correctly due to the wrong set-packet 33 received.

Meanwhile, the transmission of video and audio program from the first station 21 to the second station 22 is a one to one transmission. Therefore, when the second station 22 receives any network packets, it checks its CRC and sends back an ACK. If error occurred, the first station 21 can transmit the network packet again, which includes data-packet 34 for the video and audio program to ensure the quality of the program played by the third station 23.

The above description is only for illustration, rather than limitation. Various changes can be made by those skilled in the art without departing from the scope and spirit of the invention. For example, the IEEE802.11b standard for WLAN transmission is used for the description of the preferred embodiment of the invention. Those skilled in the art may make alternations and modifications using any of the IEEE 802.11 series of WLAN specifications. Furthermore, in the embodiment of the invention, data is transmitted in ad-hoc mode. Anyone skilled in the art may switch stations from the infrastructure mode to the ad-hoc mode to implement the embodiment of the invention, and to resume the original transmission mode after exiting the system. In addition, the first station can assign numbers to the data-packet. The third station can delete a duplicate of the received packets, according to the sequence number assigned, from retransmitted data-packet requested by the second station or repeated transmission of important video and audio data to improve the change of transmitting entire data to the third station. It is therefore contemplated that the appended claims will embrace any such alternatives, modifications and variations as falling within the true scope and spirit of the invention.

What is claimed is:

1. A one-to-many transmission method to transmit real-time video and audio data on wireless local area network (WLAN) satisfying a WLAN transmission standard and formed with a first station, a second station, and at least one third station, said first station being capable of providing simultaneous transmission of at least one video and audio program to said second station, said method comprising:
(a) using said first station to calculate for the number of said at least one video and audio program that said WLAN can accommodate, according to the bandwidth of said WLAN;
(b) transmitting a command-packet from said second station to said first station for performing a command action of said command-packet;
(c) transmitting a set-packet periodically from said first station to said second station;
(d) checking said set-packet for any errors by said second station, in which said step (b) is performed again if there is some error occurred;
(e) transmitting periodically at least one data-packet from said first station to said second station, said at least one data-packet containing at least one video and audio program; and
(f) intercepting said set-packet by said third station and, according to the configuration of said set-packet, receiving said at least one data-packet and selectively playing said at least one video and audio program contained in said at least one data-packet by said third station.

2. The method of claim 1, wherein said command action of said command-packet includes a command selected from a group consisting of Modify, Stop, Pause, and Resume.

3. The method of claim 2, wherein when said first station receives said Modify command from said command-packet, said first station carries out preparation tasks for said at least one video and audio program designated by said Modify command.

4. The method of claim 2, wherein when said first station receives said Stop command from said command-packet, said first station terminates the execution of said method.

5. The method of claim 2, wherein when said first station receives said Pause command from said command-packet, said first station sets the requested program to null and stores video and audio data of said video and audio program on a storage device, and when said first station receives said Resume command from said command-packet, said first station checks if the requested video and audio program is paused, and whether said storage device contains video and audio data of said video and audio program that has not been transmitted, if so, transmit video and audio data of said video and audio program.

6. The method of claim 1, wherein said set-packet comprises a service set identifier (SSID) and a channel number.

7. The method of claim 6, wherein said set-packet further comprises a program list of said at least one video and audio program and a data-packet number and data byte number for each of said at least one video and audio program.

8. The method of claim 1, wherein said first station in said step (e) transmits said at least one data-packet one by one, according to the sequence of said video and audio program, said at least one data-packet includes one single program of said video and audio program.

9. The method of claim 1, wherein said first station in said step (e) uses a multiplexer to integrate said at least one video and audio program and transmit said at least one data-packet, said at least one data-packet comprises said at least one video and audio program, and said second station in step (e) and/or said third station in said step (f) receives at least one data-packet, and uses a demultiplexer to pick out and play a required video and audio program.

10. The method of claim 1, wherein said third station in said step (f) scans through all transmission channels available for said WLAN to intercept said set-packet.

11. The method of claim 1, wherein said third station further deletes a duplicate of said received data-packet, according to the sequence number of said at least one data-packet.

12. The method of claim 1, wherein said WLAN transmission standard is IEEE 802.11 series of WLAN transmission standard.

13. A one-to-many transmission system for transmitting real-time video and audio data on wireless local area network (WLAN), said system comprises:
a first station providing at least one video and audio program and a set-packet and using a WLAN to transmit periodically;
a second station transmitting a command-packet to said first station to determine said at least one video and audio program transmitted by said first station, to receive said set-packet and said at least one video and audio program transmitted by said first station, and to confirm if said set-packet is correct or not; and
at least one third station scanning all transmission channels available for said WLAN to intercept said set-packet, and according to said set-packet configuration, to receive at least one data-packet and selectively play one of said at least one data-packet.

14. The system of claim 13, wherein said first station further calculates the number of said at least one video and audio program it can accommodate for said WLAN, according to the bandwidth of said WLAN.

15. The system of claim 13, wherein said set-packet includes a service set identifier (SSID) and a channel number.

16. The system of claim 15, wherein said set-packet further includes a program list of said at least one video and audio program and a packet number and byte number of data for each of said at least one video and audio program.

17. The system of claim 13, wherein said command-packet includes a command selected from a group consisting of Modify, Stop, Pause, and Resume.

18. The system of claim 13, wherein said second station checks if said set-packet contains any error, and transmit said command-packet again if an error has occurred.

19. The system of claim 13, wherein said third station deletes a duplicate of said received data-packet, according to the sequence number of said at least one data-packet.

20. The system of claim 13, wherein said transmission standard is IEEE 802.11 series of WLAN transmission standard.
